(19) United States
(12) Patent Application Publication
(10) Pub. No.: US 2008/0094024 A1
(43) Pub. Date: Apr. 24, 2008

(54) Power Supply Circuit of Dual Purpose Chargeable Accumulator

(76) Inventor: Hung-Mau Li, Yung Ting Townshipp (TW)

Correspondence Address: HDSL, 4331 STEVENS BATTLE LANE, FAIRFAX, VA, 22033, US

(21) Appl. No.: 11/551,796

(22) Filed: Oct. 23, 2006

(51) Int. Cl. H02J 7/00

(52) U.S. Cl. 320/101

(57) ABSTRACT

A power supply circuit of dual purpose chargeable accumulator includes a solar cell circuit comprising a plurality of solar energy boards, and a plurality of solar cells, wherein the solar cell circuit is connecting with an output detecting circuit, and the output detecting circuit is capable of detecting an output voltage of the solar cell; an alternating current (AC) circuit; a power selective circuit connecting with the solar cell circuit and the AC circuit; a charge battery; a charge control circuit connecting with the charge battery; a battery voltage detecting circuit connecting between the power selective circuit and the charge battery for detecting a voltage of the charge battery to select or not select the AC circuit to charge the charge battery; and a control circuit for controlling the power selective circuit to select the solar cell circuit or the AC circuit.

### BACKGROUND OF THE INVENTION

1. Field of the Invention

The present invention relates to power supply circuits of chargeable accumulators, particularly to a power supply circuit of dual purpose chargeable accumulator capable of using a solar energy and an alternating current (AC).

2. Description of the Related Art

Because of the solar energy has advantages of environmental protection, inexhaustible, and directly using, the solar energy industry has been developed well. In recent five years, an annual increasing ratio of solar cells in the global reaches to 35%, and the solar cells have utilized to various fields.

A conventional power supply circuit of a solar cell used in an outdoor lamp or similar includes a photosensitive resistor. When the photosensitive resistor senses an enough sunshine intensity, the power supply circuit absorbs a solar energy and converts it to an electric energy, and further stores the electric energy to charge the solar cell. When the photosensitive resistor senses that an environmental light intensity is not enough, the power supply circuit activates a light displaying load. However, if the solar cell can not be effectively charged in daylight because of the weather, and subsequently, the power supply circuit can not activate the light displaying load, or not activate stably.

Furthermore, during the course of operating, if the conventional power supply circuit is damaged and the solar cell can not be charged fully, a user may not find the problem until activating or stopping the operating. Therefore, the outdoor lamp or similar with the solar cell may not be normally used.

What is needed is to provide a power supply circuit of dual purpose chargeable accumulator, which can solve the above problems.

### BRIEF SUMMARY

A power supply circuit of dual purpose chargeable accumulator includes a solar cell circuit comprising a plurality of solar energy boards capable of absorbing a light energy, and a plurality of solar cells capable of converting the light energy into an electrical energy, wherein the solar cell circuit is connecting with an output detecting circuit, and the output detecting circuit is capable of detecting an output voltage of the solar cell; an alternating current (AC) circuit for providing a normal power supply; a power selective circuit connecting with the solar cell circuit and the AC circuit to select the solar cell circuit or the AC circuit; a charge battery for storing the electrical energy; a charge control circuit connecting with the charge battery for controlling the charge battery to charge or not; a battery voltage detecting circuit connecting between the power selective circuit and the charge battery for detecting a voltage of the charge battery to select or not select the AC circuit to charge the charge battery; and a control circuit connecting with a load circuit, the output detecting circuit, the power selective circuit, and the charge battery for controlling the power selective circuit to select the solar cell circuit or the AC circuit, and the control circuit capable of controlling the accumulator to supply the load circuit or charge the charge battery; wherein the output voltage of the solar cell is taken as a reference of the accumulator supplying the load circuit or charging the charge battery.

As described in the above, a control circuit connecting with a load circuit, the output detecting circuit, the power selective circuit, and the charge battery for controlling the power selective circuit to select the solar cell circuit or the AC circuit, so that the dual purpose chargeable accumulator with the power supply circuit can select the solar cell circuit or the AC circuit to supply a power. And further, a waveform occurring circuit, and a battery detecting and alarming circuit may be utilized to detect whether or not the voltage of the charge battery being damaged to increase an additional price of the dual purpose chargeable accumulator with the power supply circuit.

Other objects, advantages and novel features of the invention will become more apparent from the following detailed description when taken in conjunction with the accompanying drawings, in which:

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a block, schematic view of a power supply circuit of dual purpose chargeable accumulator in accordance with a first preferred embodiment of the present invention;

FIG. 2 is a concrete, circuit view of the power supply circuit of FIG. 1;

FIG. 3 is a schematic view of showing connections of a solar cell circuit and a control circuit of FIG. 2;

FIG. 4 is a schematic view of showing connections of an alternating current (AC) circuit and the voltage-stabilizer circuit of FIG. 2;

FIG. 5A is a schematic view of showing connections of a charge battery and a battery detecting and alarming circuit of FIG. 2;

FIG. 6 is a schematic view of showing connections of a battery voltage detecting circuit, a temperature detecting circuit, and a loading circuit of FIG. 2;

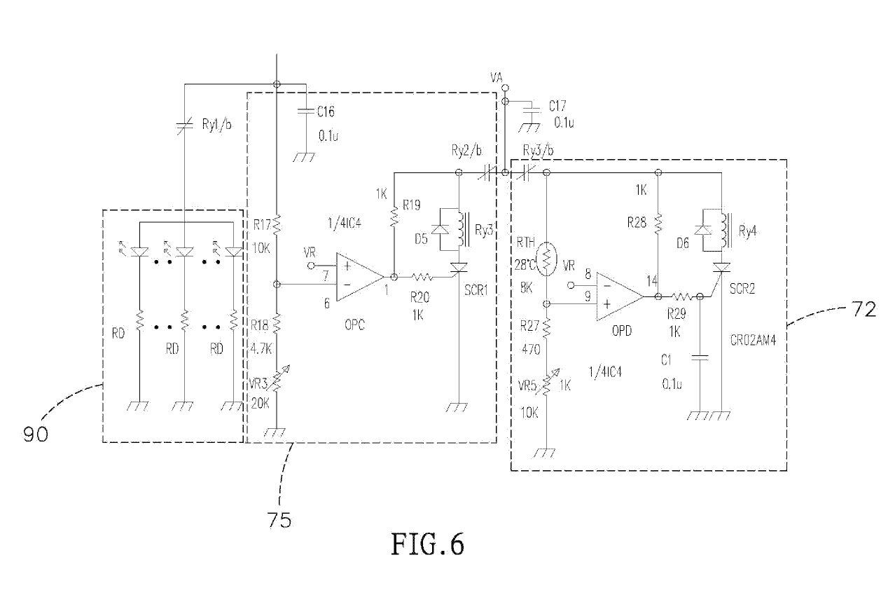

FIG. 7 is a block, schematic view of a power supply circuit of dual purpose chargeable accumulator in accordance with a second preferred embodiment of the present invention; and

FIG. 8 is a concrete, circuit view of the power supply circuit of FIG. 7;

### DETAILED DESCRIPTION

Reference will now be made to the drawings to describe preferred embodiments of the present power supply circuit of dual purpose chargeable accumulator, in detail.

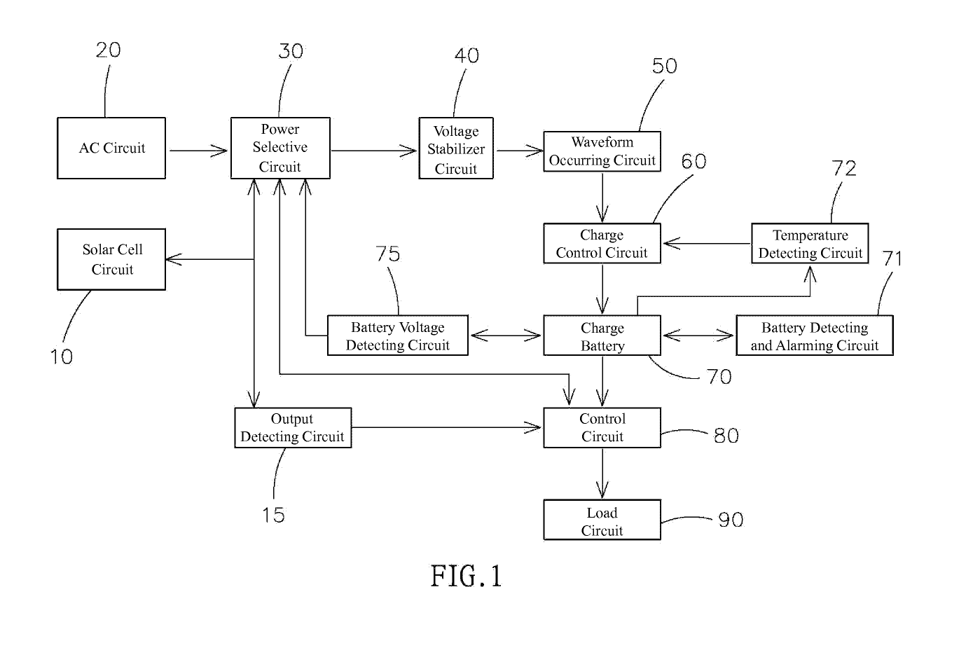

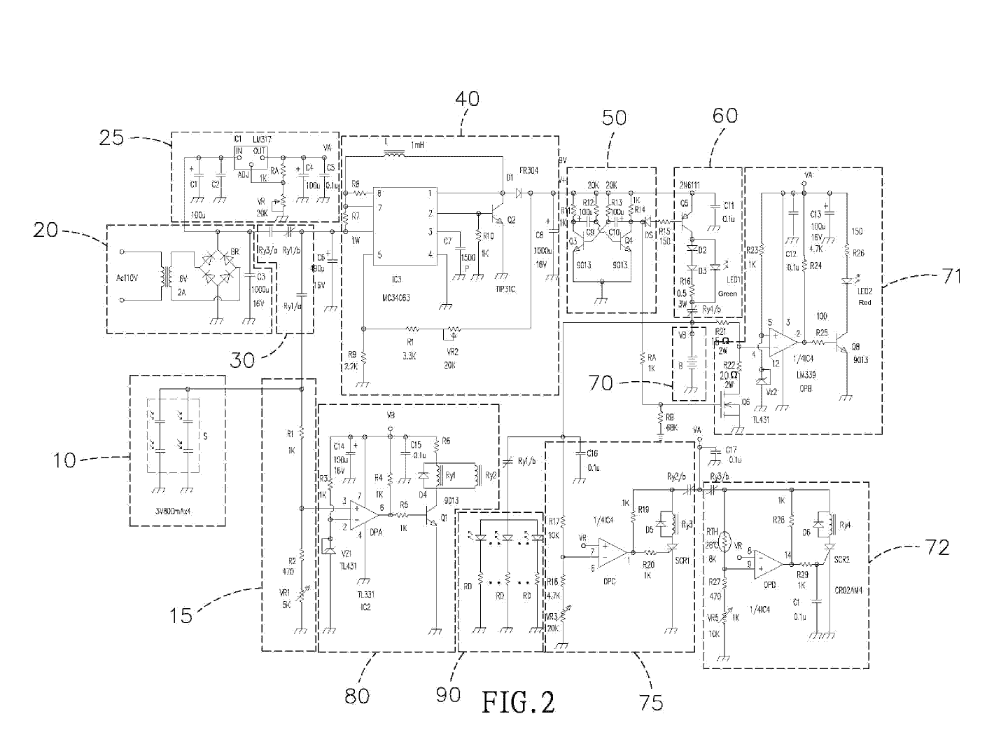

Referring to FIGS. 1 and 2, a power supply circuit of dual purpose chargeable accumulator in accordance with a first preferred embodiment of the present invention is shown. The power supply circuit of dual purpose chargeable accumulator at least includes a solar cell circuit 10, an alternating current (AC) circuit 20, a power selective circuit 30, a voltage-stabilizer circuit 40, a waveform occurring circuit 50, a charge control circuit 60, a charge battery 70 and a control circuit 80. The control circuit is further connected to a load circuit 90.

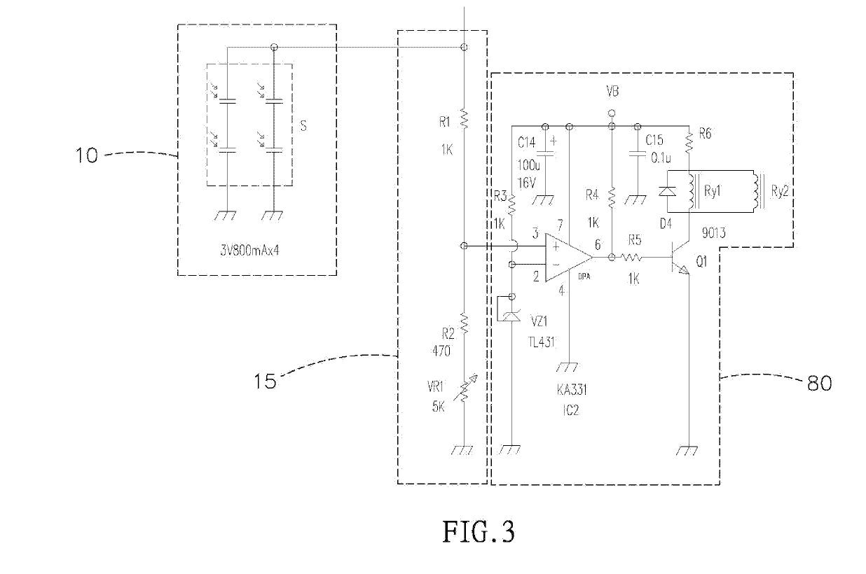

Referring to FIGS. 2 and 3, the solar cell circuit 10 includes a plurality of solar energy boards capable of absorbing a light energy, and a plurality of solar cells capable of converting the light energy into an electrical energy. The solar cell circuit 10 is connecting with an output detecting circuit 15. The output detecting circuit includes resistors R1 and R2, a variable resistor VR1, and other relative elements. An output end of the output detecting circuit 15 is connected to the power selective circuit 30, and another output end of the output detecting circuit 15 is connected to the control circuit 80. Thereby, when an output voltage of the solar cell circuit 10 is increased in daylight, the control circuit 80 controls the load circuit 90 to cut off, and control the charge battery 70 to be charged. On the other hand, when the output voltage of the solar cell circuit 10 is decreased, the control circuit 80 controls the load circuit 90 to be activated.

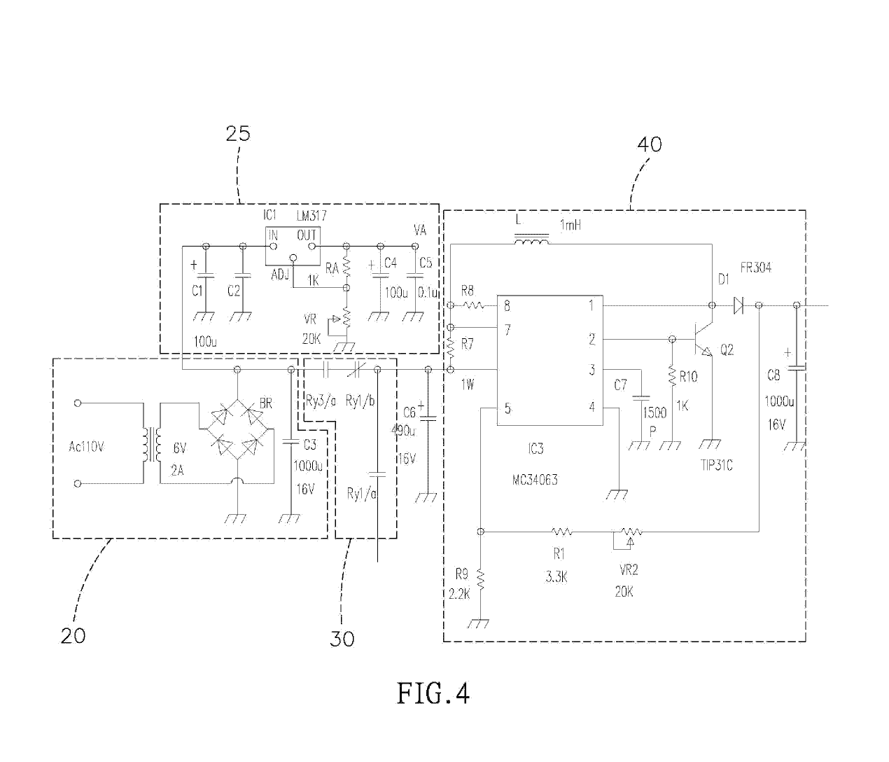

Referring to FIGS. 1 and 4, the AC circuit 20 is utilized to provide a normal power supply. The AC circuit 20 includes a rectifier BR and other relative elements. The AC circuit 20 is further connected to a voltage dropping and stabilizing circuit 25, which is utilized to drop a height voltage (such as 110 V) to a low voltage (such as 5 V) to support the power supply circuit of dual purpose chargeable accumulator. An output end of the AC circuit 20 is connected to the power selective circuit 30.

Referring to FIGS. 2 and 4, the power selective circuit 30 includes a relay RY3 and other relative elements. The power selective circuit 30 is connected to the solar cell circuit 10, the AC circuit 20 and the control circuit 80. When an electrical energy stored in the charge battery 70 is exhausted, or the solar cell circuit 10 is disable to supply a power, the power selective 30 may select the AC circuit 20 to supply a power.

Referring to FIG. 4, the voltage-stabilizer circuit 40 is connected to an output end of the power selective circuit 30. The voltage-stabilizer circuit 40 includes an integrated circuit IC3, a transistor Q2, and other relative elements. The voltage-stabilizer circuit 40 has functions of raising a voltage, dropping a voltage and limiting a current.

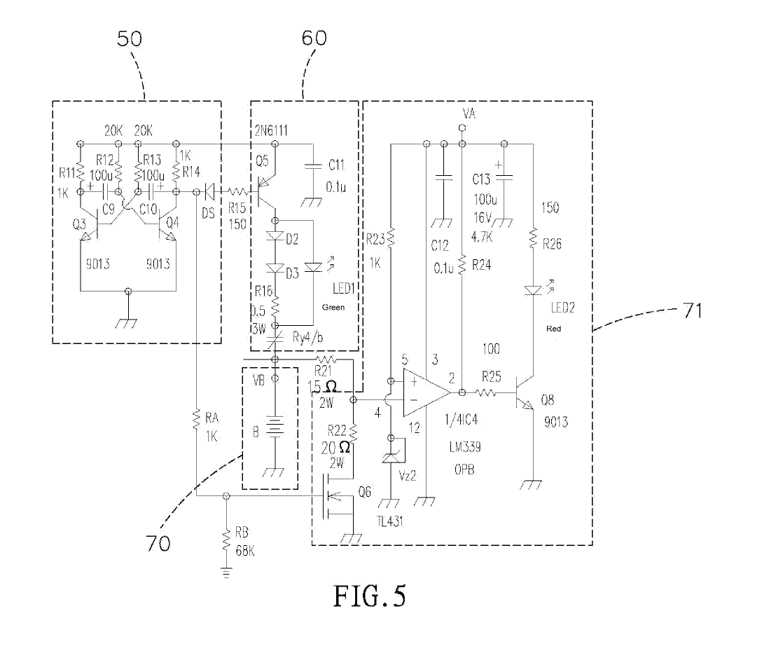

Referring to FIGS. 2 and 5, the waveform occurring circuit 50 is connected to an output end of the voltage-stabilizer circuit 40. The waveform occurring circuit 50 includes transistors Q3, Q4, a plurality of resistors R11, R12, R13, and R14, a plurality of capacitors C9, C10, and other relative elements. The waveform occurring circuit 50 can provide square-wave pulses. The waveform occurring circuit 50 is utilized to consult situations of the charge battery 70 according to a height and a duration of a waveform, and further to confirm the charge battery 70 is damaged or not.

Referring to FIGS. 2 and 5, the charge control circuit 60 is connected to an output end of the waveform occurring circuit 50. The charge control circuit 60 includes a transistor Q5, diodes D2, D3, a resistor R16, a relay RY4/b, a light emitting diode LED1 and other relative elements. The transistor Q5 is controlled by the transistor Q4 of the waveform occurring circuit 50. The diodes D2, D3, the resistor R16, and the relay RY4/b are utilized to charge the charge battery. The light emitting diode LED1 is utilized to display a charge operation.

Referring to FIGS. 2 and 5, an input end of the charge battery 70 is connected to an output end of the charge control circuit 60. The charge battery 70 is further connected a battery detecting and alarming circuit 71, and a temperature detecting circuit 72. The battery detecting and alarming circuit 71 includes an amplifier OPB, transistors Q6 and Q8, and a red light emitting diode LED2, and other relative elements. On operating, the transistor Q6 is controlled by the waveform occurring circuit 50 on or off to be able to apply a simulative load of resistors R11 and R22 connecting in series to the charge battery 70 in a short time. An output voltage of the charge battery 70 is up or under a predetermined value (such as 4V), and the transistor Q8 operates on or off to flash the red light emitting diode LED2, and thereby, to alarm an user.

The temperature detecting circuit 72 includes a relay RY4, a thermistor RTH, an amplifier OPD, a silicon control rectifier SCR2 and relative elements. When an operating temperature of the charge battery 70 is over a predetermined temperature (such as 45° C.), the temperature detecting circuit 72 enable the silicon control rectifier SCR2 and activate the relay RY4, and further, the charge control circuit 60 stop a charge operation of the charge circuit 70.

Further, a battery voltage detecting circuit 75 is connected between the power selective circuit 30 and the charge battery 70. The battery voltage detecting circuit 75 includes a relay RY3, an amplifier OPC, a silicon control rectifier SCR1 and other relative elements. The relay RY3/a of the power selective circuit 30 is activated by the silicon control rectifier SCR1 when the output voltage of the charge battery is dropped to a cutout discharge voltage. And then, the relay RY3 activates the power selective circuit 30 to select the AC circuit 20 to charge the charge battery 70, and further to protect the charge battery from discharging overly.

Referring to FIGS. 2 and 3, the control circuit 80 includes an amplifier OPA (IC2), a transistor Q1, a diode D4, relays RY1 and RY2, and other relative elements. The control circuit 80 controls the power selective circuit 30 by the relay RY1. The control circuit 80 is further connected to an output detecting circuit 15 of the solar cell circuit 10, in order to activate the load circuit 90 or not.

The load circuit 90 is connected to an output end of a node PY1/b of the relay RY1, and is activated by the control circuit 80. The load circuit 90 may be a circuit of a display device of a billboard, a signboard, a caution board or a nameplate.

Operations of the power supply circuit of dual purpose chargeable accumulator will be described in the following, in detail. In daytime, the solar cell circuit is illuminated by the sunlight, and can output a high voltage. The high voltage passes through the resistors R1, R2, and the variable resistor VR1 of the output detecting circuit 15 to the amplifier OPA of the control circuit 80. A voltage of a positive input of the amplifier OPA is higher than a voltage of a negative input of the amplifier OPA, and then the amplifier OPA outputs another high voltage to activate the transistor Q1, the relays RY1 and RY2, wherein the relay RY1/b is cut off to disable the load circuit 90 (that is, the display device is not required to be activated.). The relay RY1/a is activated to increase an output voltage of the solar cell circuit 10 by the power selective circuit 30 and the integrated circuit IC3 of the voltage-stabilizer circuit 40. And further, using the waveform occurring circuit 50 to provide a square-wave pulse, and using the transistor Q4 of the waveform occurring circuit 50 to activate the transistor Q5 of the charge control circuit 60, to facilitate to charge the charge battery 70. In addition, a current passes through the light emitting diode LED1 of the charge control circuit 60, so as to facilitate to consult a normal charge operation or not.

On night, the load circuit 90 is required to be activated. Because the solar cell circuit 10 is illuminated not enough, the solar cell circuit 10 outputs a low voltage. The low voltage passes through the resistors R1, R2, and the variable resistor VR1 of the output detecting circuit 15 to the amplifier OPA of the control circuit 80. A voltage of a positive input of the amplifier OPA is lower than a voltage of a negative input of the amplifier OPA, and then the amplifier OPA outputs another low voltage to cut off the transistor Q1, the relays RY1 and RY2, wherein the relay RY1/b is activated to enable the load circuit 90 (that is, the display device is not required to be activated.). Furthermore, when an output voltage of the charge battery 70 is lower than a cutout discharge voltage (such as 5.2V), a negative input of the amplifier OPC of the battery voltage detecting circuit 75 is enabled to be lower than a positive input of the amplifier OPC to output a high voltage, and further to activate the silicon control rectifier SCR1 and the relay RY3 to activate the relay RY3/a of the power selective circuit 30, to facilitate to select the AC circuit 20 to supply a power. An output voltage of the AC circuit 20 is increased by the power selective circuit 30 and the integrated circuit IC3 of the voltage-stabilizer circuit 40. And further, using the waveform occurring circuit 50 to provide a square-wave pulse, and using the transistor Q4 of the waveform occurring circuit 50 to activate the transistor Q5 of the charge control circuit 60, to facilitate to charge the charge battery 70. In addition, a current passes through the light emitting diode LED1 of the charge control circuit 60, so as to facilitate to consult a normal charge operation or not.

When the charge battery is damaged, and a charge operation is off, the waveform occurring circuit 50 outputting a square-wave is on a high level, the transistor Q5 is cut off, and the transistor Q6 is turned on, and to facilitate to apply a simulative load of resistors R11, R12 connecting in series to the charge battery 70. If an output voltage of the charge battery 70 is lower than 4V, a voltage of a negative input of the amplifier OPB of the battery detecting and alarming circuit 71 is lower than a voltage of a positive input of the amplifier OPB, and to facilitate the amplifier OPB to output a high voltage to activate the transistor Q8, and further to turn on the red light emitting diode LED2. When a charge operation is on (because of the charge battery being damaged, when the waveform occurring circuit 50 outputting a square-wave is on a low level, the transistor Q5 is turned on, and the transistor Q6 is cut off), a voltage of a negative input of the amplifier OPB of the battery detecting and alarming circuit 71 is higher than a voltage of a positive input of the amplifier OPB, and to facilitate the amplifier OPB to output a low voltage to cut off the transistor Q8, and further to turn off the red light emitting diode LED2. In a word, when the charge battery 70 is damaged, the charge states are always changed between on and off, thereby the red light emitting diode LED2 flashes to display the charge battery 70 being damaged, to facilitate to replace a new charge battery.

Furthermore, when the operation temperature of the charge battery is too high on operating, the thermistor RTH of the temperature detecting circuit 72 will be activated to enable a voltage of a positive input of the amplifier OPD being higher than a voltage of a negative input of the amplifier OPD. Subsequently, the amplifier OPD outputs a high voltage to activate the silicon control rectifier SCR2 and the relay RY4, wherein the relay RY4/b of the charge control circuit 60 is cut off to stop a charge operation. Furthermore, to enable the silicon control rectifier SCR2 to charge the charge battery 70 again, a voltage of the negative input of the amplifier OPC is required to be lower than a voltage of the positive input of the amplifier OPC. That is, the amplifier OPC outputs a high voltage level to activate the silicon control rectifier SCR1 and turn on the relay RY3/a of the power selective circuit 30. And then, the relay RY3/b connected to the temperature detecting circuit 72 is cut off to restart the silicon control rectifier SCR2 and the relay RY4/b. And thereby, a life time of the charge battery 70 may be increased.

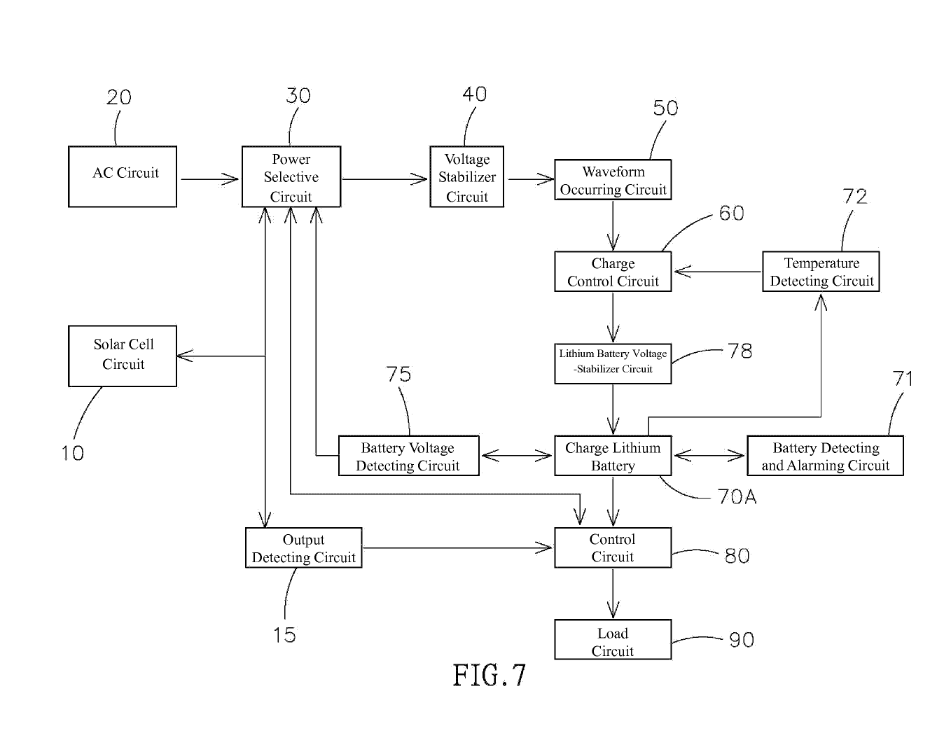

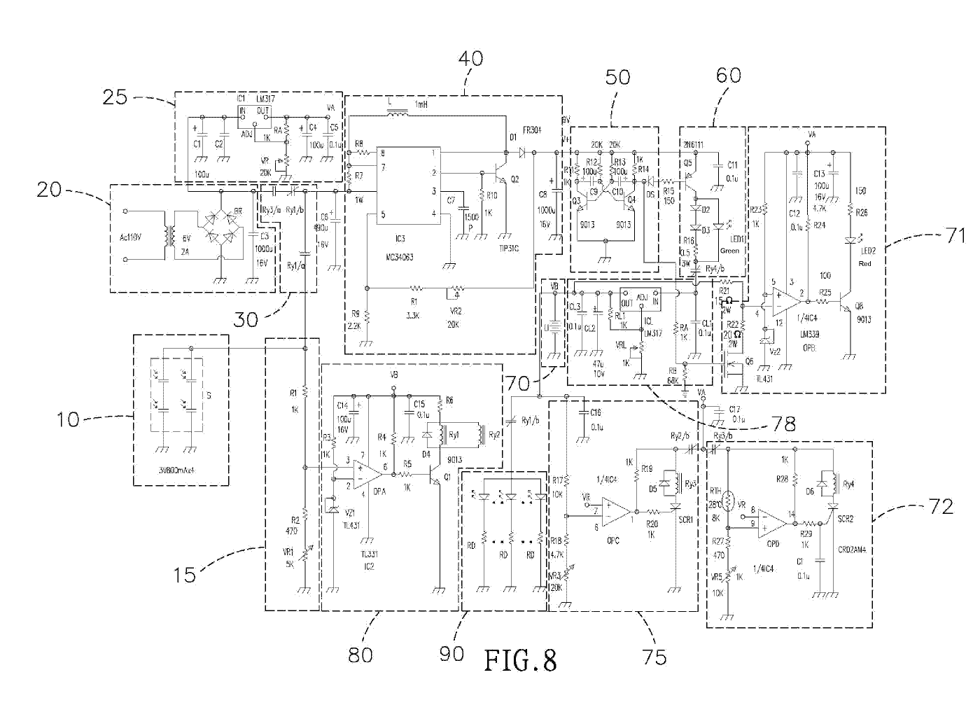

Referring to FIGS. 7 and 8, a power supply circuit of dual purpose chargeable accumulator in accordance with a second preferred embodiment of the present invention is shown. In this embodiment, a charge lithium battery 70A replaces the charge battery 70 of the first embodiment. Further, a lithium battery voltage-stabilizer circuit 78 is connected to an output end of the charge control circuit 60 and an input end of the charge lithium battery 70A, to facilitate to provide a stable charge voltage to the charge lithium battery 70A.

As described in the above, the control circuit 80 connecting with a load circuit 90, the output detecting circuit 15, the power selective circuit 30, and the charge battery 70 for controlling the power selective circuit 30 to select the solar cell circuit 10 or the AC circuit 20, so that the dual purpose chargeable accumulator with the power supply circuit can select the solar cell circuit 10 or the AC circuit 20 to supply a power. And further, a waveform occurring circuit 50, and a battery detecting and alarming circuit 7 may be utilized to detect whether or not the voltage of the charge battery 70 being damaged to increase an additional price of the dual purpose chargeable accumulator with the power supply circuit.

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A power supply circuit of dual purpose chargeable accumulator, comprising:
a solar cell circuit comprising a plurality of solar energy boards capable of absorbing a light energy, and a plurality of solar cells capable of converting the light energy into an electrical energy, wherein the solar cell circuit is connecting with an output detecting circuit, and the output detecting circuit is capable of detecting an output voltage of the solar cell;
an alternating current (AC) circuit for providing a normal power supply;
a power selective circuit connecting with the solar cell circuit and the AC circuit to select the solar cell circuit or the AC circuit;
a charge battery for storing the electrical energy;
a charge control circuit connecting with the charge battery for controlling the charge battery to charge or not;
a battery voltage detecting circuit connecting between the power selective circuit and the charge battery for detecting a voltage of the charge battery to select or not select the AC circuit to charge the charge battery;
and a control circuit connecting with a load circuit, the output detecting circuit, the power selective circuit, and the charge battery for controlling the power selective circuit to select the solar cell circuit or the AC circuit, and the control circuit capable of controlling the accumulator to supply the load circuit or charge the charge battery;
wherein the output voltage of the solar cell is taken as a reference of the accumulator supplying the load circuit or charging the charge battery.

2. The power supply circuit as claimed in claim 1, wherein the charge control circuit is further connected to a waveform occurring circuit capable of providing square-wave pulses, and a battery detecting and alarming circuit for detecting whether or not the voltage of the charge battery being under a predetermined value when the charge battery is not charged, and further for cooperating with the waveform occurring circuit to detecting whether or not the charge battery being damaged, and for providing an alarm.

3. The power supply circuit as claimed in claim 1, wherein the charge battery is further connected to a temperature detecting circuit for detecting an operating temperature of the charge battery, whereby, when the operating temperature being over a predetermined temperature, a charge operating is stopped to protect the charge battery.

4. The power supply circuit as claimed in claim 1, wherein the load circuit is a circuit of a display device of a billboard, a signboard, a caution board or a nameplate.

5. The power supply circuit as claimed in claim 1, wherein the charge battery is a charge lithium battery, and the charge lithium battery is further connecting a lithium battery voltage-stabilizer circuit for providing a stable charge voltage.

6. The power supply circuit as claimed in claim 1, wherein the AC circuit further comprising a voltage-stabilizer circuit.

7. The power supply circuit as claimed in claim 1, wherein the power selective circuit is further connected to a voltage-stabilizer circuit, and the voltage-stabilizer circuit is connecting with an output end of the power selective circuit.
